(19) United States
(12) Patent Application Publication
(10) Pub. No.: US 2005/0285396 A1
(43) Pub. Date: Dec. 29, 2005

(54) Plumbing adapter

(76) Inventor: John Martineau, Stamford, CT (US)

Correspondence Address: ST. ONGE STEWARD JOHNSTON & REENS, LLC, 986 BEDFORD STREET, STAMFORD, CT, 06905-5619, US

(21) Appl. No.: 10/996,731

(22) Filed: Nov. 24, 2004

Related U.S. Application Data
(60) Provisional application No. 60/583,103, filed on Jun. 25, 2004.

(51) Int. Cl. F16L 25/00; F16L 35/00

(52) U.S. Cl. 285/328

(57) ABSTRACT

The invention relates to a plumbing adapter having a tube with a first end and a second end, where the first end includes a fitting adapted to connect the tube to rough plumbing, and where the second end includes a sealer removably attached to the second end for sealing and unsealing the tube.

### FIELD OF THE INVENTION

The invention relates to an improved adapter used for connecting pipes in the field of plumbing.

### BACKGROUND OF THE INVENTION

Plumbing products generally known in the trade as “stub-outs” or “stub ells” are usually shaped like the letter “L” and typically connect the plumbing system of the residence, most of which lies within the wall or runs along or through the floors joists, and the final control device. The final control device is normally the stop valve under the vanity, near the toilet, under the kitchen sink, or that which connects to the tub spout.

Stub-outs, or adapters, are normally made of copper tube, usually ½″ nominal in size, but are sometimes made out of ¾″ nominal copper tube. Their function is typically the same, except that the ¾″ stub-out has greater capacity, in terms of flow rate, owing to its larger diameter. But, for the most part, they are made of ½″ nominal copper tubing.

The stub-out typically incorporates a brass fitting at one end, which is usually attached to the copper tubing by means of solder. Soldering the fitting to the end of the stub-out normally entails time and effort in addition to posing a safety hazard due to the heat and open flame. At the other end, the copper tubing is formed into a bullet shape and sealed, typically by using flame, flux and solder. FIG. 1 depicts a stub-out known in the prior art.

In practice, the plumbing system, commonly known as the “rough” plumbing, is run through the walls or through and along the floors joists before the finished flooring has been installed and before the wallboard has been applied. Therefore, all the wall studs are normally visible and the floor joists are usually accessible. The rough plumbing is usually run to each point of use, such as a sink, a vanity, a toilet, a washing machine, a bathtub, and/or a shower. A stub-out, or adapter, is often attached to each termination point of the rough plumbing, and the “stub-out” will make a transition from the rough plumbing to some point beyond where the finished surface will be.

Once the rough plumbing is completed, it may be checked for leaks prior to attaching final control devices. Checking for leaks usually entails pressurizing the entire plumbing system with air. If the system passes, and there are no leaks, the system may be depressurized and the task of putting up wallboard and closing up all the walls may begin. The rough plumbing will then normally be concealed behind the walls or floors except for the bullet-nosed ends of the stub-outs.

The “finished” plumbing may be installed and attached to the exposed parts of the stub-outs. Normally, prior to attaching finished plumbing, the bullet-nosed end of the stub-out may be cut off and de-burred to clean off any metal shavings or other debris. This usually takes some time and effort to properly clean and de-burr the cut. Moreover, plumbers may cut themselves in the process.

What is desired, therefore, is a stub-out that reduces time and effort to install. Another desire is to provide a stub-out that reduces safety hazards normally encountered while soldering or de-burring a stub-out. A further desire is a stub-out that is easy to install to rough and/or finished plumbing.

### SUMMARY OF THE INVENTION

It is, therefore, an object of the invention to provide a stub-out that is easy to install and use with rough or finished plumbing.

Another object is to provide a stub-out that eliminates the steps of soldering, cutting, and/or de-burring so that safety hazards are reduced.

A further object is a stub-out that reduces installation time or effort.

These and other objects of the invention are achieved by a plumbing adapter having a tube with a first end and a second end, where the first end includes a fitting adapted to connect the tube to rough plumbing, and where the second end includes a sealer removably attached to the second end for sealing and unsealing the tube. The fitting may be crimped or sweated onto the first end.

In some embodiments, the fitting is integrally connected with the first end of the tube. In other embodiments, the second end and sealer each includes threads where the second end and sealer are matingly threaded together.

Optionally, the second end may have a protrusion extending in a radially inward direction from a localized area of an inner diameter of the second end, where the sealer may be removably attached to the protrusion.

In another embodiment, the plumbing adapter includes a tube having a first end and a second end, the first end is adapted to connect the tube to rough plumbing. The second end has an inner diameter with a protrusion extending radially inward from a localized area of the inner diameter, where a sealer is removably attached to the second end for sealing and unsealing the tube. The sealer has a closer removably attached to an anchoring mechanism and the anchoring mechanism is attached to the protrusion. An attachment device is adapted to be attachable to the anchoring mechanism just like the closer so that the closer and adjustment device are interchangeable.

One manner for removably attaching the closer and adjustment device would be to thread both of them the same way so that each may mate with the threads of the anchoring mechanism. In this fashion, a valve may be connected to the attachment device so that it is removably attached to the anchoring mechanism.

In a variation of this embodiment, the adapter may have an internal member with a notch wherein the internal member is inserted into the second end to the point where the protrusion engages with the notch for securing the internal member to the protrusion. A valve may be threaded or integrally attached to the internal member.

In another embodiment, a plumbing adapter includes a tube having a first end and a second end, where the first end is adapted to connect the tube to rough plumbing and the second end is of a deformable material. A valve with a notched insert is inserted into the second end and the second end is deformed so that the second end is bent within the notch for securing the valve to the tube.

### BRIEF DESCRIPTION OF THE DRAWINGS

FIG. 1 depicts the plumbing adapter in accordance with the prior art.

FIG. 2 depicts the plumbing adapter in accordance with the invention.

FIG. 3 depicts the second end of the plumbing adapter shown in FIG. 2.

FIG. 4 depicts another view of the second end of the plumbing adapter shown in FIG. 2.

FIG. 5 depicts a valve attached to the second end of the plumbing adapter shown in FIG. 2.

FIG. 6 depicts an internal member to be inserted into the second end of the plumbing adapter shown in FIG. 2.

FIG. 7 depicts the internal member inserted into the second end of the plumbing adapter shown in FIG. 2.

FIG. 8 depicts a threaded second end of the plumbing adapter shown in FIG. 2.

FIG. 9 depicts a valve threaded onto the second end of the plumbing adapter shown in FIG. 2.

FIG. 10 depicts another valve threaded onto the second end of the plumbing adapter shown in FIG. 2.

FIGS. 11a and 11b depict a valve crimped onto the second end of the plumbing adapter shown in FIG. 2.

### DETAILED DESCRIPTION OF THE DRAWINGS

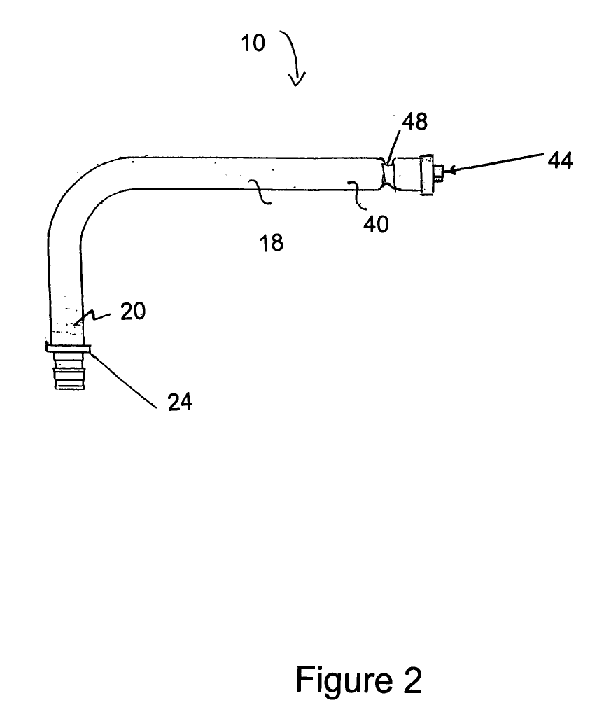

FIG. 2 depict adapter 10 in accordance with the invention. Adapter 10 includes elongated tube 18 having first end 20 and second end 40 where fitting 24 is attached to first end 20 and sealer 44 is attached to second end 40.

Fitting 24 is shown to be a connection between first end 20 and the rough plumbing. Fitting 24 may be threaded so that it may be screwed to the rough plumbing. In other embodiments, fitting 24 may be sweated or welded to the rough plumbing. As shown, fitting 24 is crimped to first end 20 but, in further embodiments, may be adhered or screwed to first end 20 by mating threads on both first end 20 and fitting 24. In a further embodiment, first end 20 and fitting 24 are integrally connected or formed, perhaps by high speed spinning during tube forming. Integrally connecting first end 20 to fitting 24 may yield the following advantages: First, one hundred percent automated fabrication of the stub-out, with the virtual elimination of labor content. Second, total elimination (where a removable plug is used) or a partial elimination of heat, flame, acid flux, solder in the manufacturing processes used in manufacture of these stub-out items. Third, due to automation, much improved quality and uniformity of the fabricated items. Fourth, the elimination of a potential leak point where the brass fitting is joined to the copper tube.

By crimping fitting 24 to first end 20, the entire process of fabricating a stub-out can be easily automated. Moreover, there will no longer be any requirement for heat, flame, acid flux, or solder, thus eliminating flame, fire danger, fuel expense, and workplace health and safety hazards. And tube 18 will not have to be sanded and/or wire brushed to expose bare copper, prior to soldering, because the entire soldering process will disappear, and the need to prepare the end to be soldered by disclosing bare copper.

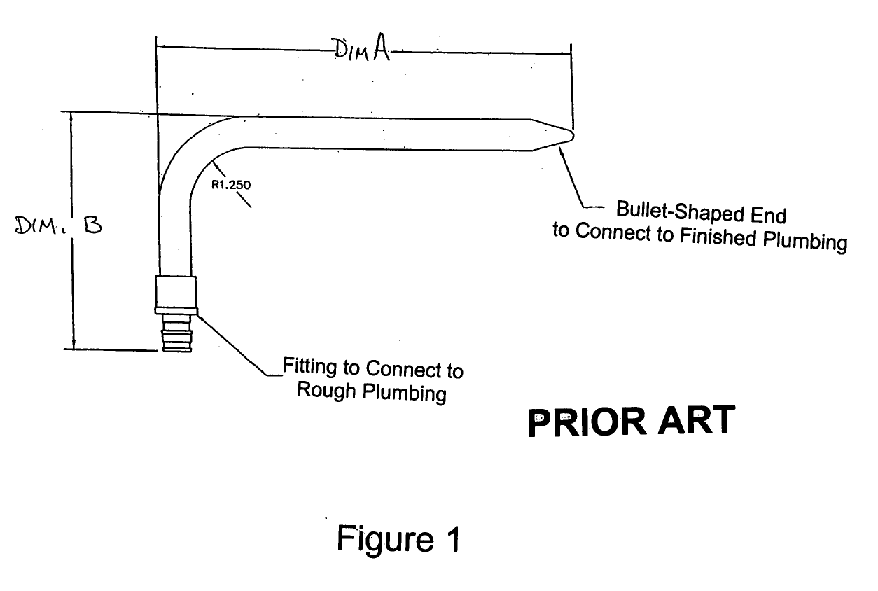

Sealer 44 does away with the traditional bullet shaped end shown in the prior art of FIG. 1 and described above. This is because, in most applications, the bullet shaped end was used until pressure testing was completed, whereupon the bullet shaped end was then cut off and discarded.

As shown, sealer 44 is threaded onto second end 40, where second end 40 is also threaded to mate with sealer 44. In other embodiments, sealer 44 is merely pushed into second end 40, or vice versa, whereby sealer 44 and second end 40 are connected to one another by interference fit. In a further embodiment, the temporary seal or plug can be applied in the factory automatically.

After the system is pressure tested, sealer 44 will be unthreaded and removed. The time and expense of cutting off the bullet shaped end, deburring the cut, removing any remaining metal slivers, and cleaning out the cut end are eliminated. Also, there will be material savings since there will no longer be any discarded second ends 40 from stub-outs.

Additional savings may be realized in the cases where the plumber does not properly clean out metal filings, or slivers of metal, after cutting the bullet shaped end prior to installation of the finished plumbing. In those cases, they end up fouling the faucets, increasing repairs to the plumbing system, and/or the filings end up in somebody's intestinal tract.

Further savings may be realized when purchasing later stub-outs. It is envisioned that stub-outs may be sold with and without sealer 44, where the latter would be cheaper. The plumber will re-use sealer 44 from a previous installation with the stub-outs purchased without sealer 44.

Optionally, second end 40 includes groove 48 for placement of o-ring 49 for enhancing a fluid tight seal when connected with finished plumbing. It is best if the radially-inward groove 48 is formed into the tube at the factory, but such radially-inward groove could likewise be imparted at the worksite with a special grooving tool.

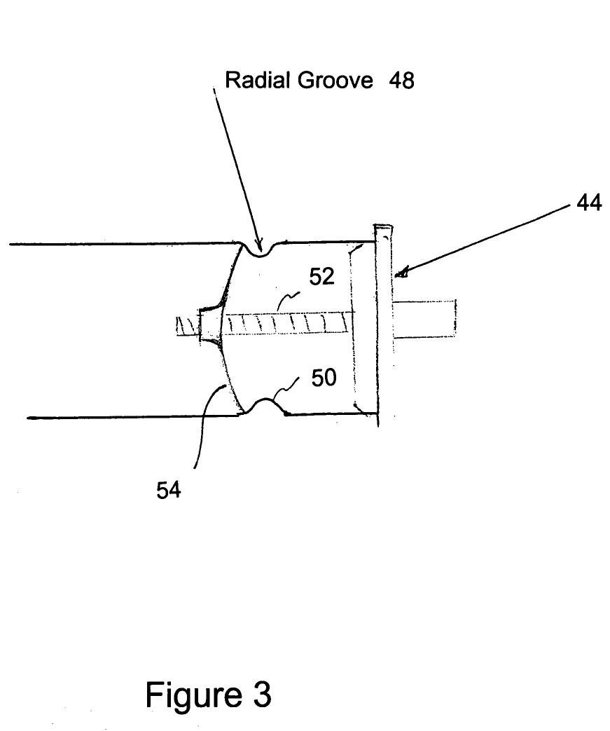

In addition, groove 48 may provide ridge 50, or a protrusion, inside the tube (see FIG. 3) so that it may be possible to design a sealer that can snap in place behind ridge 50 to provide positive anchoring and sealing of second end 40. Ridge 50, or protrusion, may extend radially inward in a localized area of the inner diameter of second end 90. In other embodiments, protrusion 50 extends around the entire inner diameter.

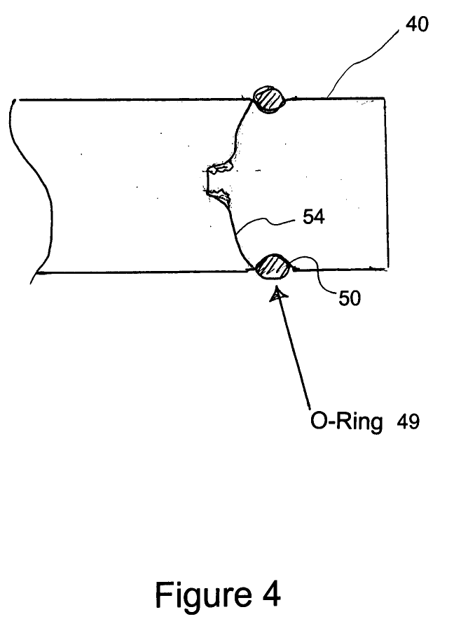

FIG. 3 shows a variation of sealer 44 where sealer 44 also includes closer 52 threaded into anchoring mechanism 54. After sealer 44 is removed by unthreading closer 52 from anchoring mechanism 54, the result would be adapter 10 as shown in FIG. 4.

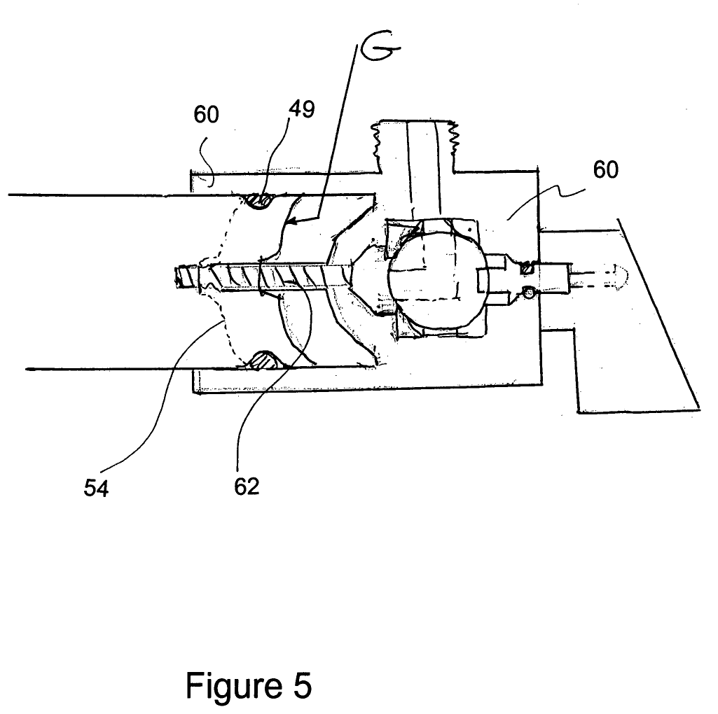

As shown in FIG. 4, tube 18 is open and anchoring mechanism 54 is lodged behind protrusion 50. Anchoring mechanism 54 snaps into position behind protrusion 50, as shown in FIG. 4. Valve 60 of special design may be installed by attachment device 62 that screws, or threads, into the threads of anchoring mechanism 54. Anchoring mechanism 54 provides a secure anchor for valve 60 to prevent accidental removal of valve 60. See FIG. 5. Attachment device 62 is interchangeable with closer 52 because both have the same threads to matingly engage with anchoring mechanism 54. Attachment device 62 may vary from closer 52 in any other physical characteristic and/or shape and need not be the same as closer 52. O-ring 49 provides a fluid tight seal with valve 60.

The process of installation is more specifically described as follows: a) Sealer 44 is removed leaving anchoring mechanism 54 secured to protrusion 50. b) Next, O-ring 49 is installed onto the radially oriented groove 48. c) Next, valve 60 of special design, having a central, threaded attachment device 62 is installed. Valve 60 is threaded until the valve inlet cavity bottoms against the end of the tube. The diameter of the valve inlet portion is made to specification provided by the standards, and the O-ring is sized in such a manner as to provide a liquid seal. The advantage of this type of valve is obvious in that no tools are required. No heat, no flame, no solder, and no wrenches are required, as with traditional types of valves available on the market.

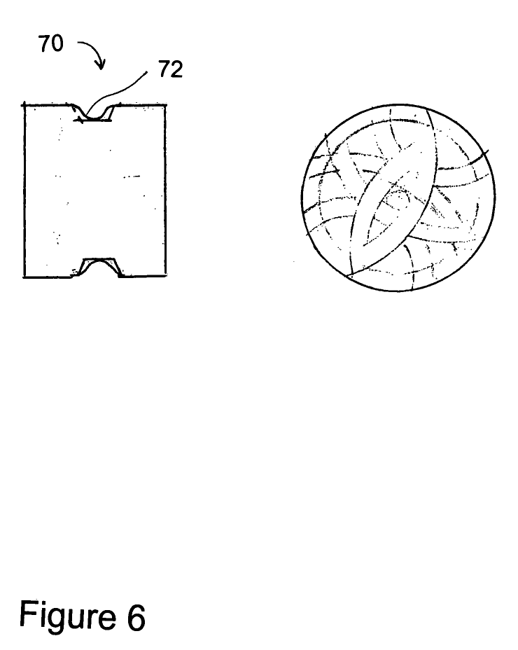

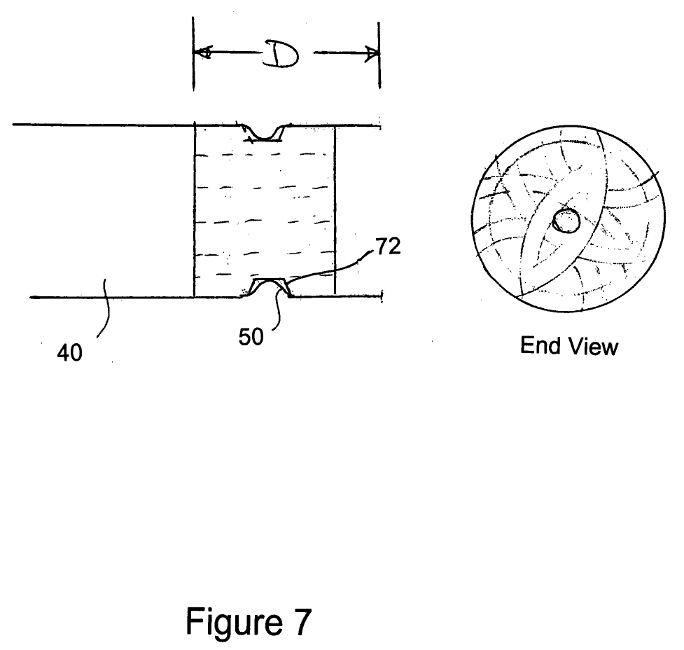

In a further, alternate improvement to adapter 10, shown in FIG. 6, internal member 70 with external groove 72 in an outer diameter of internal member 72 is used instead of anchoring mechanism 54. Internal member 70 with radially oriented groove 72, either cut or molded into it, is inserted into second end 40 to a desired depth “D” as shown in FIG. 7. Groove 72 mates with protrusion 50, thereby locking internal member 70 in place in an axial position. Being anchored axially in tube 18, internal member 70 will be properly positioned to accept valve 60, which by means of a threaded or bayonet-type connecting device, will connect to internal member 70. Prior to final connection of valve 60, O-ring 49 would be installed into groove 48 of second end 40.

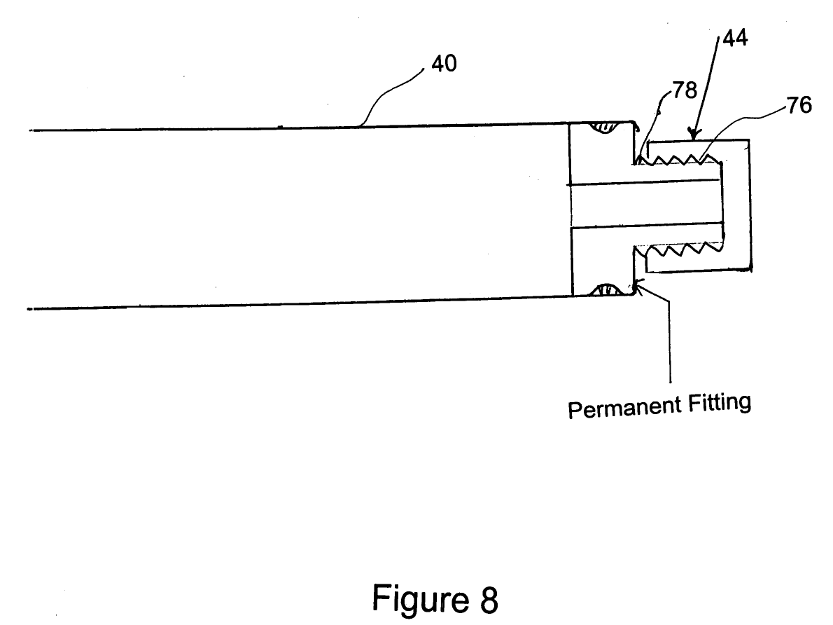

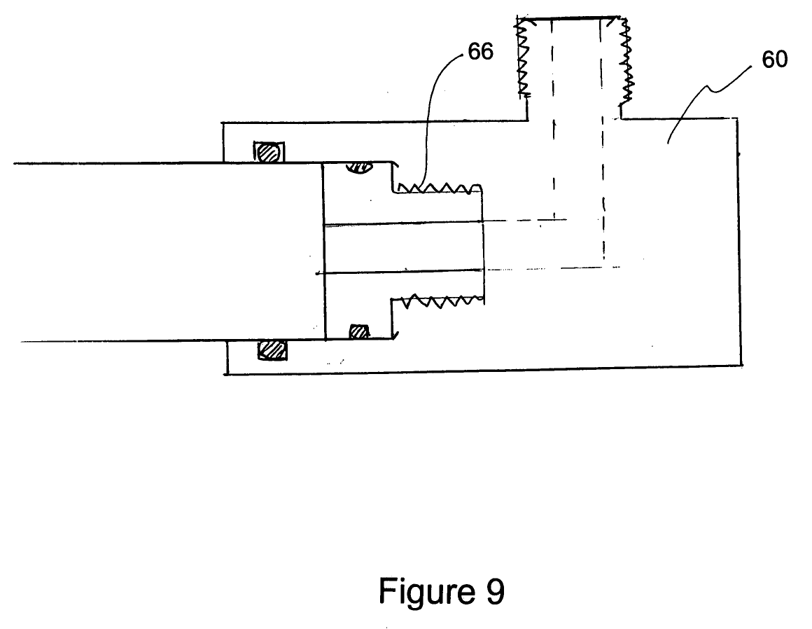

FIG. 8 depicts another embodiment of the invention where sealer 44 includes threads 76 for removably attaching to threads 78 of second end 40. After pressure testing, the threaded sealer 44 is removed and valve 60, also with threads 66 for matingly attaching to threads 76, is mounted. See FIG. 9. Valve 60 as pictured in FIG. 9 is equipped with O-ring 49, or other elastomeric seal member, in the bore of the tube 18 engaging end. The elastomeric seal provides the fluid seal, while the thread engagement between male and female ends, respectively, provide for mechanical holding of valve 60 to second end 40. In practice, the valve is very easy to install, since there is. no requirement for torch, sweat, solder, heat, flame, tools, or even Teflon tape or pipe dope. No tools are required.

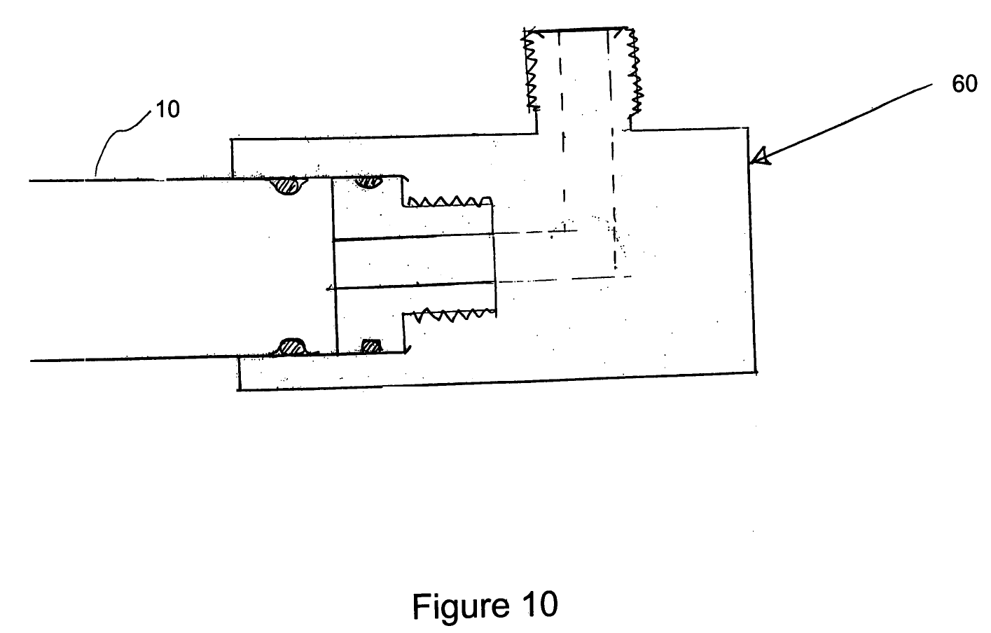

In yet another embodiment, FIG. 10 shows adapter 10 and valve 60 equipped with two o-ring grooves and two o-rings. After pressure testing, sealer 44 is removed and a first o-ring is mounted onto a first external, radially-oriented sealing groove. Next, valve 60 is mounted onto the end of the stub-out. Note that the specially designed valve, in this instance, has no internally-mounted o-ring, or other elastomeric seal, since there is one now mounted (or mountable) on the o-ring groove of the tube. Although pictured with female engaging threads, to engage a permanent sealing plug element with matching male threads, it is understood that the valve could as easily be provided with male threads, to engage female threads of a permanent sealing member at the end of the stub-out.

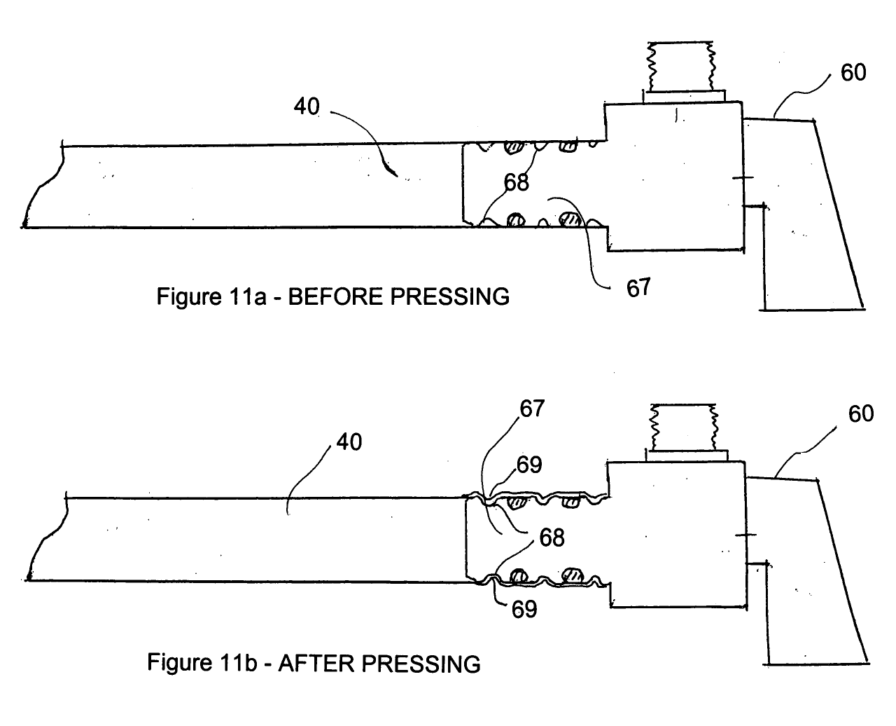

FIG. 11a and 11b depict another embodiment of connecting second end 40 and valve 60. As shown in FIG. 11a, valve 60 includes insert 67 for insertion into second end 40. Insert 67 further includes notch 68. Second end 40 is made of a deformable material so that it may be crimped, or deformed. As shown in FIG. 11b, second end 40 is crimped so that bend 69 forms in second end 40 as a result of an external force placed on second end 40. When bend 69 is formed in notch 68, second end 40 and insert 67 are locked together, thereby securing valve 60 to second end 40. The final result is that it will then be much more difficult (practically impossible) to separate valve 60 from tube 18, thereby effecting a permanent seal, and also providing visual confirmation that the two members, tube 18 and valve 60, have been irreversibly combined. A further means of verification, should one be deemed necessary, is to provide the plumber with a fixed caliper (a “go, no-go gauge”) that will tell him that sufficient compression has occurred, and that the installation is complete and to specification.

1. A plumbing adapter for connection to rough plumbing, comprising:
a tube having a first end and a second end;
said first end includes a fitting adapted to connect said tube to said rough plumbing; and
said second end includes a sealer removably attached to said second end for sealing and unsealing said tube.

2. The adapter according to claim 1, wherein said fitting is integrally connected with said first end of said tube.

3. The adapter according to claim 1, wherein said second end includes threads.

4. The adapter according to claim 3, wherein said sealer includes threads for mating with said threads of said second end.

5. The adapter according to claim 1, wherein said second end has an inner diameter.

6. The adapter according to claim 5, wherein said second end further comprises a protrusion extending from a localized area of said inner diameter in a radially inward direction.

7. The adapter according to claim 6, wherein said localized area extends around an entire said inner diameter.

8. The adapter according to claim 6, wherein said localized area extends around a part of said inner diameter.

9. The adapter according to claim 6, wherein said sealer includes an anchoring mechanism attached to said protrusion and a closer removably attached to said anchoring mechanism.

10. An improved plumbing adapter for connection to rough plumbing, comprising:
a tube having a first end and a second end;
said first end adapted to connect said tube to said rough plumbing;
a sealer removably attached to said second end for sealing and unsealing said tube;
said second end includes an inner diameter;
said second end includes a protrusion extending from a localized area of said inner diameter in a radially inward direction;
said sealer having an anchoring mechanism attached to said protrusion and a closer removably attached to said anchoring mechanism;
an attachment device adapted to be attachable to said anchoring mechanism; and
wherein said closer is interchangable with said attachment device.

11. The adapted according to claim 10, wherein said anchoring mechanism includes threads.

12. The adapter according to claim 10, wherein said attachment device includes threads for matingly engaging with said threads of said anchoring mechanism.

13. The adapter according to claim 10, further comprising a valve connected to said attachment device.

14. The adapter according to claim 13, wherein said valve is integrally connected to said attachment device.

15. An improved plumbing adapter for connection to rough plumbing, comprising:
a tube having a first end and a second end;
said first end adapted to connect said tube to said rough plumbing;
said second end includes an inner diameter;
said second end includes a protrusion extending from a localized area of said inner diameter in a radially inward direction;
an internal member having a notch;
wherein said protrusion engages with said notch for securing said internal member to said protrusion.

16. The adapter according to claim 15, further comprising a valve connected to said internal member.

17. The adapter according to claim 16, wherein said valve is integrally connected to said internal member.

18. The adapter according to claim 16, wherein said valve is removably connected to said internal member.

19. The adapter according to claim 18, wherein said valve and said internal member each includes threads for matingly engaging said valve and said internal member.

20. An improved plumbing adapter for connection to rough plumbing, comprising:
a tube having a first end and a second end;
said first end adapted to connect said tube to said rough plumbing;
said second end being of a deformable material;
a valve having an insert adapted to be inserted into said second end;
said insert includes a notch;
wherein said insert is placed within said second end; and
wherein said second end is deformed so that said second end includes a bend within said notch for securing said valve to said tube.
